(19) United States
(12) Patent Application Publication
(10) Pub. No.: US 2026/0131384 A1
(43) Pub. Date: May 14, 2026

(54) 3-D PRINTER FOR PRINTING MIXTURE OF FIRST AND SECOND MATERIALS IN A VARYING RATIO

(71) Applicant: Grid Logic Incorporated, Lapeer, MI (US)

(72) Inventors: Matthew James Holcomb, Metamora, MI (US); Ira James Holcomb, JR., Oxford, MI (US)

(73) Assignee: Grid Logic Incorporated, Lapeer, MI (US)

(21) Appl. No.: 19/340,336

(22) Filed: Sep. 25, 2025

Related U.S. Application Data
(60) Provisional application No. 63/699,525, filed on Sep. 26, 2024.

(51) Int. Cl. B22F 10/85; B22F 10/34; B22F 12/52; B22F 12/55; B22F 12/57; B22F 12/58; B22F 12/90; B33Y 10/00; B33Y 30/00; B33Y 40/00; B33Y 50/02

(52) U.S. Cl. CPC B22F 10/85; B22F 10/34; B22F 12/52; B22F 12/55; B22F 12/57; B22F 12/58; B22F 12/90; B33Y 10/00; B33Y 30/00; B33Y 40/00; B33Y 50/02

(57) ABSTRACT

A toolpath generator generates a toolpath for a three-dimensional part. A material ratio generator determines a ratio of first and second powders in a mixture that varies in the three dimensions based on a point cloud. A printer has a printhead configured to print a three-dimensional part with first and second powders having a mixture of first and second powders in a ratio of represented by the varying ratio in three dimensions.

### CROSS-REFERENCE TO RELATED APPLICATIONS

This application claims priority from U.S. Provisional Patent Application No. 63/699,525, filed on Sep. 26, 2025, all of which is incorporated herein by reference in its entirety.

### BACKGROUND OF THE INVENTION

### 1). Field of the Invention

This invention relates to a printing system and its method of use for making a part and to a toolpath computer and its use during the process of making a part.

### 2). Discussion of Related Art

Traditional part manufacture required machining of metals and other materials into required shapes. Modern manufacture has evolved to where some parts can be printed using three-dimensional printers. Plastic parts may, for example, be printed by heating a plastic material to above its melting temperature and using a printhead to lay the plastic material down in a layer-by-layer fashion, which after it hardens, forms a three-dimensional shape. We have also shown that it is possible to print three-dimensional shapes using fine powders and then heating the powders to join particles of the powders. We have shown that the particles can be joined by heating the particles with the printhead during the actual print, by heating the particles after each layer or slice has been printed, or by heating the particles after the entire three-dimensional shape has been printed.

### SUMMARY OF THE INVENTION

The invention provides a printing system including a frame, first and second hoppers to hold first and second powders respectively, a movable mechanism mounted to the frame, a printhead mounted through the movable mounting mechanism to the frame and connected to the first and second powder hoppers, a print surface mounted to the frame, at least one motor connected between the frame and the movable mounting mechanism to move the printhead relative to the print surface, at least one processor, a computer-readable medium connected to the at least one processor, a toolpath stored on the computer-readable medium, a varying ratio stored on the computer-readable medium, a set of instructions on the computer-readable medium and executable by the at least one processor, including a printhead controller logically connected to the toolpath and the varying ratio, the at least one motor being connected to the at least one processor for the printhead controller to move the printhead relative to the print surface and print a mixture of the first and second powders in accordance with the varying ratio along the toolpath.

The invention also provides using a printer including a frame, first and second hoppers to hold first and second powders respectively, a movable mechanism mounted to the frame, a printhead mounted through the movable mounting mechanism to the frame and connected to the first and second powder hoppers, a print surface mounted to the frame; at least one motor connected between the frame and the movable mounting mechanism to move the printhead relative to the print surface, at least one processor, and a computer-readable medium connected to the at least one processor, a method of making a part including storing a toolpath on the computer-readable medium, storing a varying ratio on the computer-readable medium, storing a set of instructions on the computer-readable medium, and executing the set of instructions by the at least one processor, including executing a printhead controller logically connected to the toolpath and the varying ratio, the at least one motor being connected to the at least one processor for the printhead controller to move the printhead relative to the print surface and print a mixture of the first and second powders in accordance with the varying ratio along the toolpath.

The invention further provides a toolpath computer including at least one processor, a computer-readable medium connected to the at least one processor, a set of instructions on the computer-readable medium and executable by the at least one processor, including a toolpath generator to generate a toolpath and store the toolpath on the computer-readable medium, and a material ratio generator to determine a varying ratio of first and second powders along the toolpath and store the varying ratio along the toolpath on the computer-readable medium.

The invention also provides a method of making a part including executing by the at least one processor a toolpath generator stored on a computer-readable medium to generate a toolpath and store the toolpath on the computer-readable medium, and executing by the at least one processor a material ratio generator stored on the computer-readable medium to determine a varying ratio of first and second powders along the toolpath and store the varying ratio along the toolpath on the computer-readable medium.

The invention also provides a part including a body having in x-, y- and z orthogonal axes and being made of a mixture of first and second materials, wherein, in a first cross-section in an x-y plane parallel to the x- and y axes, a ratio of the first and second materials changes on a first line in a direction parallel to the x axis and changes in a direction parallel to the y axis.

### BRIEF DESCRIPTION OF THE DRAWINGS

The invention is further described by way of example with reference to the accompanying drawings, wherein:

FIG. 1 is a partial perspective view and partial block diagram of a printing system according to an embodiment of the invention;

FIG. 2 is a cross-sectional side view of a printhead of the printing system;

FIGS. 3A and 3B are bottom views of first and second separate powder metering shutters forming part of the printhead;

FIG. 4A is a graph illustrating measured deposition against a setting for the first separate powder metering shutter;

FIG. 4B is a graph similar to FIG. 4A with a fit that is used for an algorithm that is used for programming the functioning of the first separate powder metering shutter;

FIG. 4C is a graph illustrating error between the measurements in FIG. 4A and the fit in FIG. 4B;

FIG. 5 is a block diagram of a toolpath computer and a printer including a printer computer forming part of the printing system;

FIG. 6 is a diagram representing operational components of the printing system;

FIG. 7 is a perspective view illustrating a three-dimensional point cloud;

FIG. 8A illustrates various stages for analyzing a first horizontal slice of the point cloud to determine a varying ratio of first and second powders for a section of a toolpath;

FIG. 8B illustrates various stages for analyzing a second horizontal slice of the point cloud to determine a varying ratio of first and second powders for a section of a toolpath;

FIG. 8C illustrates various stages for analyzing a vertical slice of the point cloud to determine a varying ratio of first and second powders for a section of a toolpath; and

FIGS. 9A to 9F illustrate the use of a Fast Fourier Transform (FFT) acceleration/deceleration algorithm to calculate changes in print speed as a function of both velocity and material composition.

### DETAILED DESCRIPTION OF THE INVENTION

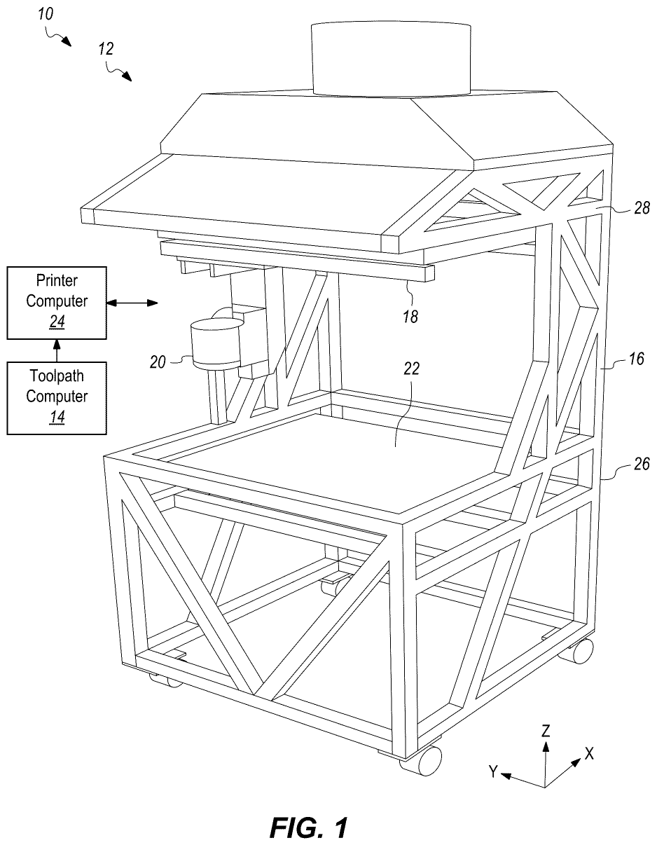

FIG. 1 shows a printing system 10 that includes a printer 12 and a toolpath computer 14.

The printer 12 includes a frame 16, a moveable mechanism 18, a printhead 20, a print surface 22, and a printer computer 24.

The frame 16 has a base portion 26 and an upper portion 28. The moveable mechanism 18 is mounted to the upper portion 28. The printhead 20 is mounted to the moveable mechanism 18. The print surface 22 is mounted to the base portion 26. The print surface 22 forms a horizontal plane extending in x- and y-directions.

The moveable mechanism 18 allows for movement of the printhead 20 in x-, y-, and z-directions. The printhead 20 is thus moveable relative to the print surface 22 in x-, y-, and z-directions. In another embodiment, a printhead may be mounted in a stationary position to a frame and a print surface may be mounted to the frame for movement in x-, y-, and z-directions relative to the frame. Alternatively, relative movement between a printhead and a print surface may be accomplished by moving a printhead in x-, and y-directions relative to a frame, and moving print surface in a z-direction relative to the frame. The moveable mechanism 18 is an x-y gantry with a z-axis, although a different system may include a moveable mechanism that uses a different arrangement for x-, y-, and z-movement of a printhead.

The printer computer 24 controls movement of and dispensing by the printhead 20. The toolpath computer 14 is connected to the printer computer 24 and is used for creating instructions for the printer computer 24. In the given example, two computers are described, although it should be understood that the same functionality that is described herein using two computers can be carried out with one computer or by more than two computers.

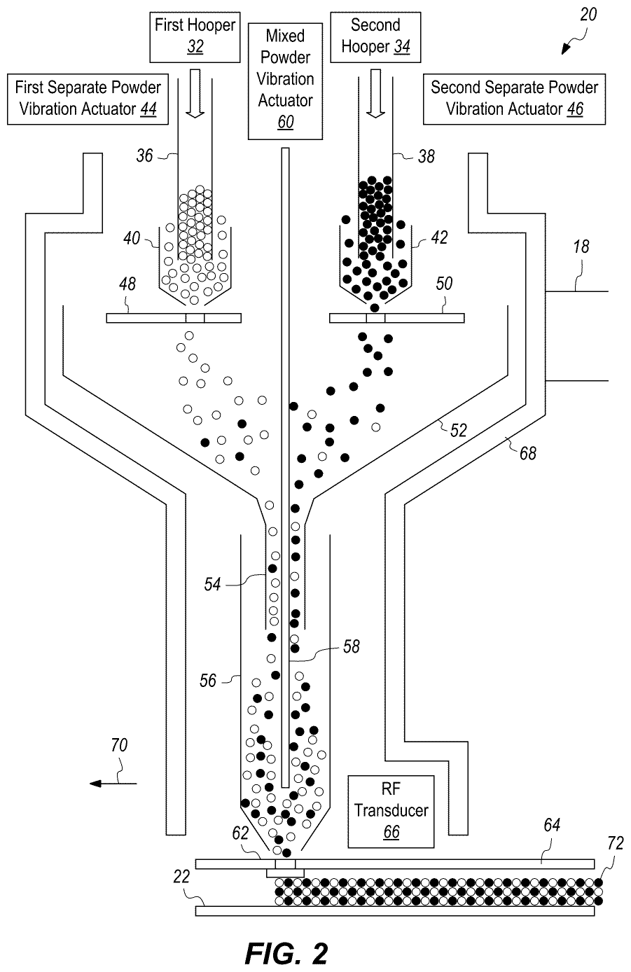

A shown in FIG. 2, the printhead 20 includes first and second hoppers 32 and 34, first and second feed tubes 36 and 38, first and second separate powder fluidization chambers 40 and 42, first and second separate powder vibration actuators 44 and 46, first and second powder metering shutters 48 and 50, a mixed powder funnel 52, a mixed powder feed tube 54, a mixed powder fluidization chamber 56, a mixed powder actuator 58, a mixed powder vibration actuator 60, a mixed powder shutter 62, a screed 64, a radio frequency (RF) transducer 66, and a mounting structure 68. The components 32 to 66 of the printer 12 are mounted directly or indirectly to the mounting structure 68 and the mounting structure 68 is secured to the moveable mechanism 18.

In use, the printhead 20 is a controllable gravity feed system. A first powder is located in the first hopper 32. The first powder falls from the first hopper 32 into the first feed tube 36. The first separate powder fluidization chamber 40 is located below and around a lower end of the first feed tube 36. The first separate powder vibration actuator 44 is physically connected to the first feed tube 36. The first powder becomes compacted when it begins to fill the first separate powder fluidization chamber 40 and a lower end of the first feed tube 36. When compacted, the first powder will not flow over the upper end of the first separate powder fluidization chamber 40. When the vibration actuator 44 of the first feed tube 36 is turned on, the powder is fluidized in the powder fluidization chamber 40 but only rises to a level below the upper limit of the fluidization chamber 40 and slightly above the bottom of the first feed tube 36. The first separate powder vibration actuator 44 can, at any time, be switched off to stop the fluidization of the first powder from the first separate powder fluidization chamber 40. When the vibration starts, the powder is fluidized in the chamber, but the flow stops when the fluidized level reaches a certain equilibrium level above the bottom of the feed tube 36. The equilibrium level is a function of the vibration magnitude of the feed tube 36 in the first separate powder fluidization chamber 40.

The first separate powder metering shutter 48 is moveable to the left and to the right so that an aperture thereof functions to open and close the lower end of the first separate powder fluidization chamber 40. The first separate powder metering shutter 48 receives the first powder from the first separate powder fluidization chamber 40 and, by moving to the left and to the right, controls dispensing of the first powder from the first separate powder fluidization chamber 40 into the mixed powder funnel 52, the mixed powder feed tube 54, and the mixed powder fluidization chamber 56.

A second powder is located in the second hopper 34. The functioning of the second hopper 34, second feed tube 38, second separate powder fluidization chamber 42, second separate powder vibration actuator 46, and second separate metering shutter 50 are the same as the functioning of the first hopper 32, first feed tube 36, first separate powder fluidization chamber 40, first separate powder vibration actuator 44, and first separate powder metering shutter 48, respectively.

The first and second powder continue to mix as they pass through the mixed powder funnel 52, mixed powder feed tube 54, and into the mixed powder fluidization chamber 56. The mixture of the first and second powders becomes compacted in the mixed powder fluidization chamber 56, which disallows the mixture from flowing out of a lower end of the mixed powder fluidization chamber 56. The mixed powder actuator 58 extends through the mixed powder funnel 52, the mixed powder feed tube 54, and into the mixed powder fluidization chamber 56. The mixed powder vibration actuator 60 is physically connected to the mixed powder actuator 58. When the mixed powder vibration actuator 60 is switched on, it vibrates the mixed powder actuator 58, and the mixed powder actuator 58 fluidizes the mixture in the mixed powder fluidization chamber 56. Vibration of the mixed powder actuator 58 also fluidizes and assists in the mixing of the first and second powders in the mixed powder funnel 52 and the mixed powder feed tube 54. When the mixture is fluidized in the mixed powder fluidization chamber 56, the mixture can flow out of a lower end of the mixed powder fluidization chamber 56. The mixed powder vibration actuator 60 can, at any time, be switched off so that the mixture in the mixed powder fluidization chamber 56 will compact to stop its flow from the lower end of the mixed powder fluidization chamber 56.

The mixed powder shutter 62 is located below the mixed powder fluidization chamber 56 to receive the mixture from the mixed powder fluidization chamber 56. The mixed powder shutter 62 is moveable to the left and to the right to control flow of the mixture out of the lower end of the mixed powder fluidization chamber 56. Ultimately, it can be said that the mixed powder shutter 62 receives the first and second powders from the first and second hoppers 32 and 34, and also from all the intermediate components of the printhead 20 between the first and second hoppers 32 and 34 and the mixed powder fluidization chamber 56. By moving the mixed powder shutter 62 to the left or to the right, an aperture of the mixed powder shutter 62 controls flow of the mixture on to the print surface 22.

The arrow 70 represents movement of the printhead 20 to the left relative to the print surface 22. By continuing to dispense the mixture, the mixture forms a deposit 72 of loose powder on the print surface 22. When the mixed powder shutter 62 is open, the screed 64 provides a resistance for powder to flow freely from the mixed powder fluidization chamber 56 on to the print surface 22. Less powder will flow on to the print surface 22 when there is less movement as shown by the arrow 70 and more powder will flow when there is more movement. The screed 64 thus provides a “self-screeding” function that levels the deposit 72 on the print surface 22.

The RF transducer 66 is mounted above the screed 64 and may be incorporated within the screed 64. The RF transducer 66, when powered on, is operable to detect a composition of the deposit 72 during the print.

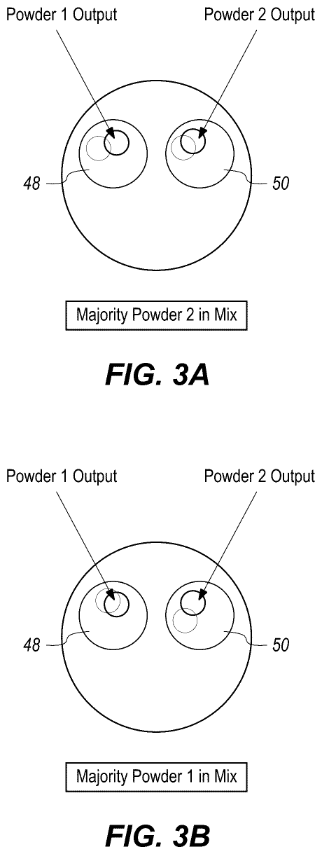

FIGS. 3A and 3B illustrate how a ratio of the first and second powders in the mixture can be adjusted. In FIG. 3A, the first separate powder metering shutter 48 is almost completely closed and the second separate powder metering shutter 50 is approximately 50% open. The setting shown in FIG. 3A will result in a mixture that has higher percentage of the second powder and a lower percentage of first powder. The mixture may, for example, consist of 70% of the second powder and 30% of the first powder by volume.

In FIG. 3B, the first separate powder metering shutter 48 is almost entirely open and the second separate powder metering shutter 50 is nearly closed. The setting in FIG. 3B will result in a mixture having a ratio wherein the first powder forms a larger fraction and the second powder forms a smaller fraction. In the setting in FIG. 3B, the mixture may, for example, have 92% of the first powder and 8% of the second powder by volume.

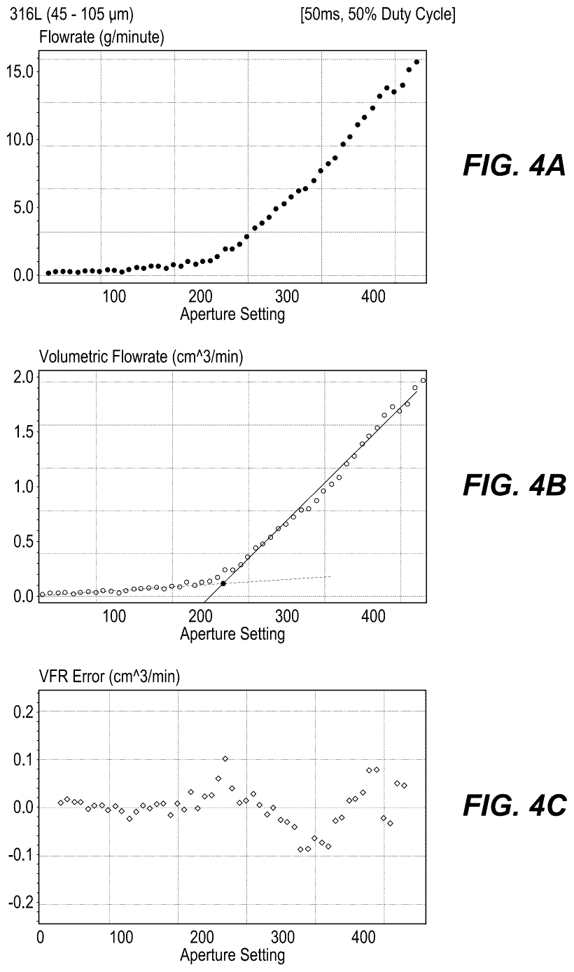

FIG. 4A shows measured flow rates for 316L powder for the first separate powder metering shutter 48 as a function of aperture setting. Flow rates increase nearly linearly with aperture setting, with a low slope up to approximately 200 and a higher slope for aperture settings from 200 to approximately 450. As shown in FIG. 4B, volumetric flow rate data (i.e., mass flow rate/material density) are then fit using a piecewise process consisting of at least two straight lines. A “crossover” point is determined at the intersection of the two straight lines which can then be used in a control algorithm to determine parameters for each specific straight line (e.g., slope and intercept) that can then be used to set the volumetric flow rate during a print. As shown in FIG. 4C, error data between the measurements shown in FIG. 4A and the piecewise linear fit in FIG. 4B is less than approximately ±0.1 cm3/minute at higher flow rates.

Because the dispensing rate through a particular shutter is governed by two linear functions, as opposed to a single linear function, it may be necessary to modulate frequency, duty cycle, and opening area of each of the first and second separate powder metering shutters 48 and 50.

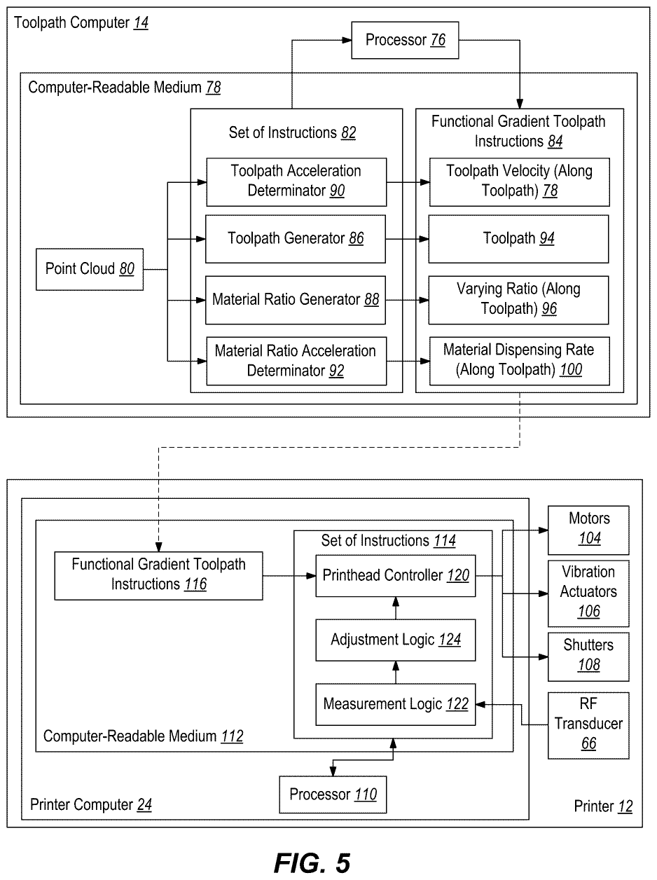

As shown in FIG. 5, the toolpath computer 14 includes a processor 76, a computer-readable medium 78, a point cloud 80, a set of instructions 82, and functional gradient toolpath instructions 84. The processor 76 is connected to the computer-readable medium 78. The set of instructions 82 is executable by the processor 76 to generate and store the functional gradient toolpath instruction 84 on the computer-readable medium 78.

The set of instructions 82 includes a toolpath generator 86, a material ratio generator 88, a toolpath acceleration determinator 90, and a material ratio acceleration determinator 92.

In use, the point cloud 80 is loaded on to the computer-readable medium 78 by an operator. The operator then executes the set of instructions 82. The toolpath generator 86 generates a toolpath 94, and stores it in the functional gradient toolpath instructions 84. The material ratio generator 88 generates a varying ratio along the toolpath representing a varying ratio 96 of the first material to the second material that has to be printed along the toolpath, and stores it in the functional gradient toolpath instructions 84. The toolpath acceleration determinator 90 calculates a toolpath velocity 98 along the toolpath, and stores it in the functional gradient toolpath instructions 84. The toolpath velocity 98 is modulated to allow for acceleration and deceleration of the printhead 20 on a circuitous path. The material ratio acceleration determinator 92 calculates a material dispensing rate 100 along the toolpath, and stores it in the functional gradient toolpath instructions 84. The material dispensing rate 100 is modulated to match or at least approach changes in velocity of the toolpath as represented in the toolpath velocity 98 along the toolpath.

The printer 12 includes the printer computer 24, various motors 104, various vibration actuators 106, various shutters 108, and the RF transducer 66. The vibration actuators 106 include the first and second separate powder vibration actuators 44 and 46 and the mixed powder actuator 58 described with reference to FIG. 2. The shutters 108 include the first and second separate powder metering shutters 48 and 50 and the mixed powder shutter 62 described with reference to FIG. 2.

The printer computer 24 includes a processor 110, a computer-readable medium 112, and a set of instructions 114 stored on the computer-readable medium 112. The processor 110 is connected to the computer-readable medium 112 and is capable of reading and executing the set of instructions 114.

In use, an operator loads the functional gradient toolpath instruction 84 from the toolpath computer 14 onto the computer-readable medium 112, which is represented as the functional gradient toolpath instructions 116. The operator then instructs the processor 110 to execute the set of instructions 114.

The set of instructions 114 includes printhead controller 120, a measurement logic 122, and an adjustment logic 124. The printhead controller 120 is logically connected to the functional gradient toolpath instructions 116. The motors 104, vibration actuators 106, and shutters 108 are electrically and logically connected to the printhead controller 120. The RF transducer 66 is electrically and logically connected to the measurement logic 122. The adjustment logic 124 is logically connected to the measurement logic 122, and the printhead controller 120 is logically connected to the adjustment logic 124.

In use, the printhead controller 120 controls the motors 104, vibration actuators 106, and shutters 108 in accordance with the functional gradient toolpath instructions 116. The motors 104 move the moveable mechanism 118 and the moveable mechanism 118 moves the printhead 20 (see FIG. 1). The printhead controller 120 also controls the vibration actuators 106 and the shutters 108 while simultaneously moving the printhead 20 along the toolpath.

The RF transducer 66 measures the material while the printhead 20 moves along the toolpath. The measurement logic 122 receives measurements from the RF transducer 66. The measurement logic 122 also analyzes and interprets the data received from the RF transducer 66. The adjustment logic 124 receives the interpreted data from the measurement logic 122 and adjusts the printhead controller 120 in order to maintain the ratio of the first and second material within a specified tolerance.

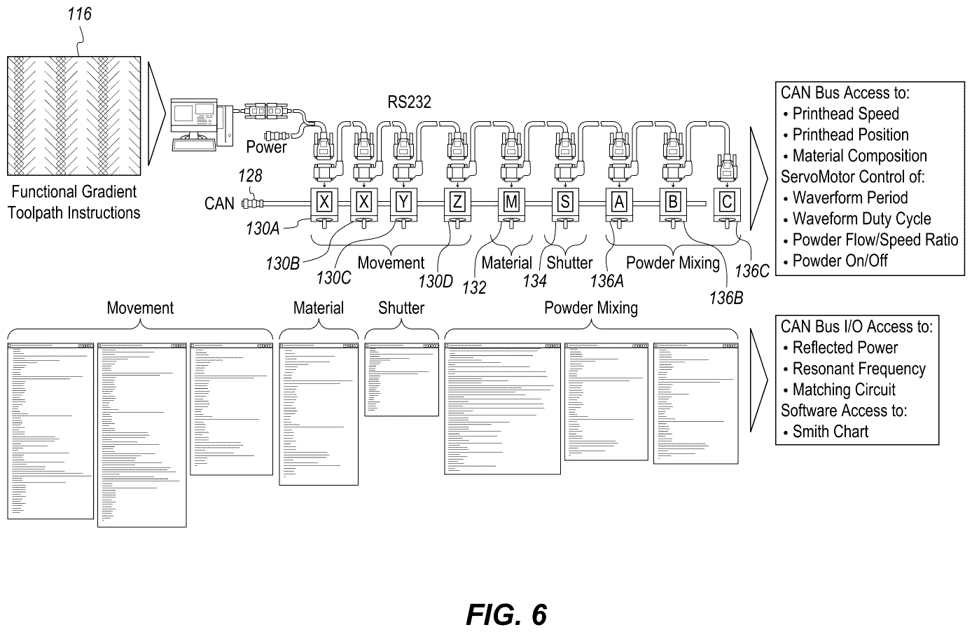

FIG. 6 illustrates a CAN Bus 128, four movement motors 130A to 130D, a material dispensing actuator 132, a shutter actuator 134 and three powder mixing actuators 136A to 136C. The movement motors 130A to 130D, the material dispensing actuator 132, the shutter actuator 134 and the powder mixing actuators 136A to 136C are all connected on the same CAN Bus 128, and therefore logically to one another. The movement motors 130A to 130D, the material dispensing actuator 132, the shutter actuator 134 and the powder mixing actuators 136A to 136C are all connected through RS232 connectors to the printer computer 24. FIG. 6 also shows that the functional gradient toolpath instructions 116 include a section that has been labelled “Movement” representing the toolpath 94 and the toolpath velocity 98 along the toolpath (see FIG. 5), a section labelled “Material” representing the varying ratio 96 along the toolpath and the material dispensing rate 100 along the toolpath (see FIG. 5), a section labelled “Shutter” and a section labelled “Powder Mixing”. The three sections in the functional gradient toolpath instructions 116 generally correspond to and control the respective groups of motors and actuators, namely the movement motors 130A to 130D, the material dispensing actuator 132, the shutter actuator 134 and the powder mixing actuators 136A to 136C.

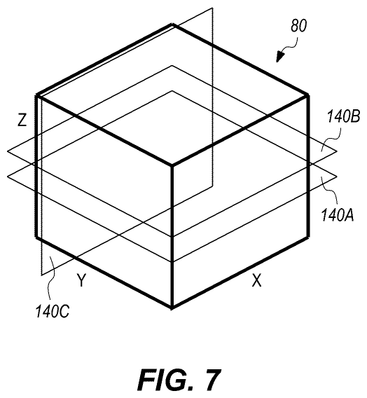

FIG. 7 illustrates the point cloud 80 that is stored in the toolpath computer 14 (See FIG. 5). The point cloud 80 is represented as a cube with x-, y-, and z-coordinates. Several horizontal x-y slices are taken through the point cloud 80 as represented by first and second slices 140A and 140B. One vertical slice is taken through the point cloud 80 as represented by a slice 140C.

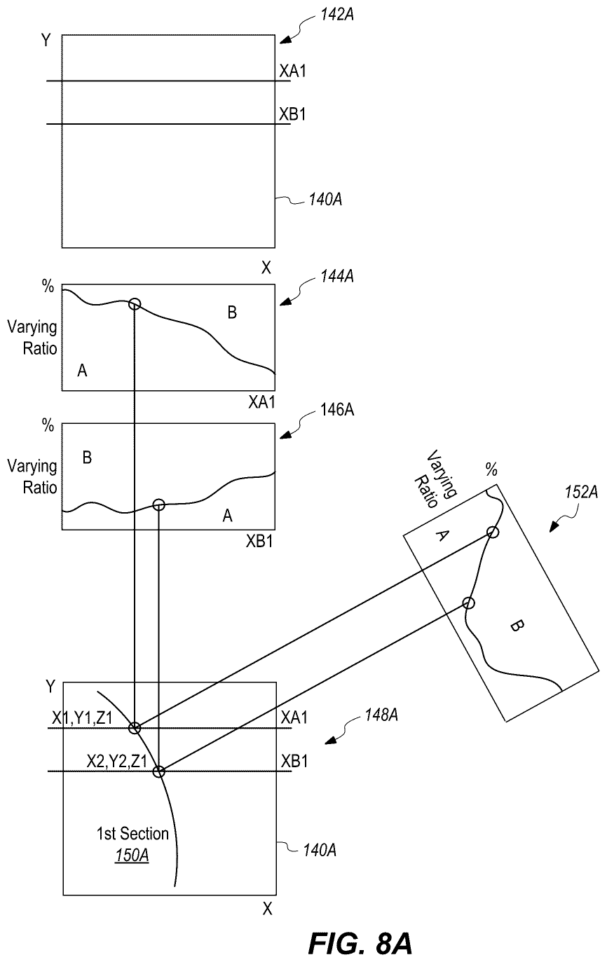

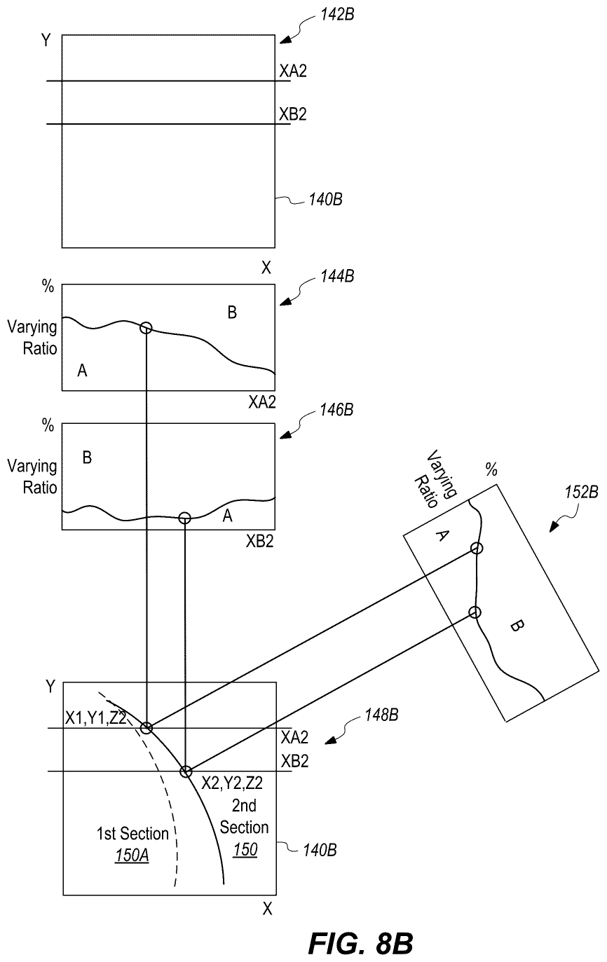

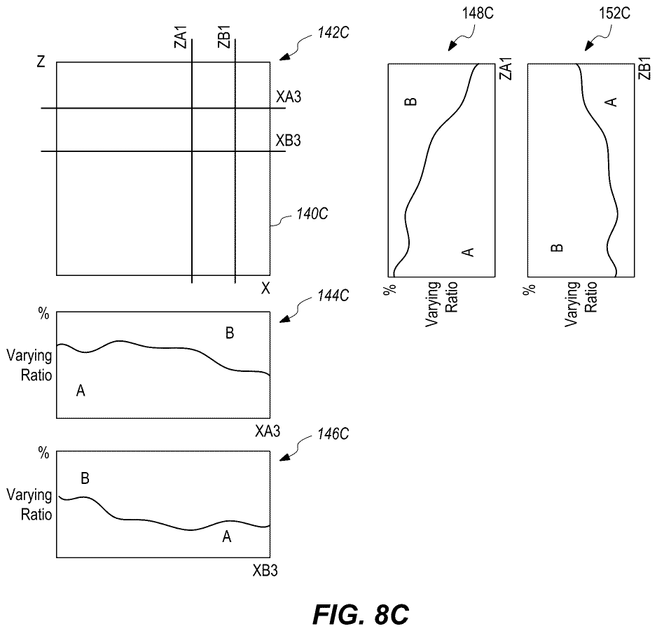

The top portion 142A in FIG. 8A shows the first slice 140A having x-and y-coordinates. The ratio of the first powder and second powder in the mixture varies in the two-dimensional plane represented in the top portion 142A. The second portion 144A in FIG. 8A shows the ratio of the first powder to the second powder (represented as “A”, and “B” respectively) along a line XA1 in the top portion 142A. The third portion 146A in FIG. 8A represents the ratio of the first and second materials along a line XB1 in the top portion 142A. A bottom portion 148A in FIG. 8A shows the first slice 140A with a first section 150A of a toolpath. A ratio of the first powder to the second powder in the mixture at X1, Y1, Z1 is obtained from the second portion 144A. A ratio of the first powder to the second powder at X2, Y2, Z1 is obtained from the third portion 146A. As shown in a side portion 152A of FIG. 8A, a ratio of the first powder to the second powder along the first section 150A of the toolpath can be obtained from the bottom portion 148A. The first section 150A of the toolpath may have a two-dimensional shape as shown in the bottom portion 148A.

The top portion 142B in FIG. 8B shows the second slice 140B having x- and y-coordinates. The ratio of the first powder and second powder in the mixture varies in the two-dimensional plane represented in the top portion 142B. The second portion 144B in FIG. 8B shows the ratio of the first powder to the second powder (represented as “A”, and “B” respectively) along a line XA2 in the top portion 142B. The third portion 146B in FIG. 8B represents the ratio of the first and second materials along a line XB2 in the top portion 142A. A bottom portion 148A in FIG. 8A shows the first slice 140A with a second section 150B of a toolpath. A ratio of the first powder to the second powder in the mixture at X1, Y1, Z2 is obtained from the second portion 144B. A ratio of the first powder to the second powder at X2, Y2, Z2 is obtained from the third portion 146C. As shown in a side portion 152B of FIG. 8B, a ratio of the first powder to the second powder along the second section 150A of the toolpath can be obtained from the bottom portion 148A. The second section 150A of the toolpath may have a two-dimensional shape as shown in the bottom portion 148A.

Each section 150A and 150B of the toolpath may have a two-dimensional shape. A three-dimensional model can be constructed from various sections of the toolpath and the model can have a ratio of the first powder to the second powder that varies in three dimensions.

The top left portion 142C in FIG. 8C shows the vertical slice 140C having x- and z-coordinates. The ratio of the first powder and second powder in the mixture varies in the two-dimensional plane represented in the top portion 142C. The second portion 144C in FIG. 8C shows the ratio of the first powder to the second powder (represented as “A”, and “B” respectively) along a line XA3 in the top portion 142C. The third portion 146C in FIG. 8C represents the ratio of the first and second materials along a line XB3 in the top portion 142C.

The fourth portion 148C in FIG. 8C shows the ratio of the first powder to the second powder (represented as “A”, and “B” respectively) along a line ZA1 in the top left portion 142C. The fifth portion 152C in FIG. 8C represents the ratio of the first and second materials along a line ZB1 in the top left portion 142C.

The entire part may be printed in loose powder form and then be heated to consolidate the particles of the powder. While the loose powder for the part is being printed, a container that holds the powder together may simultaneously be printed. Alternatively, the loose powder can be printed inside a container that holds the powder together. The powder of the part will have a ratio that varies in three dimensions in the same way as the point cloud 80 (see FIGS. 7, 8A, 8B and 8C). Once the particles of the powders in the mixture have been heated to consolidate them and then cooled down the final part will have a body with materials that are consolidated so that the body is a stand-alone body.

The body of the part has the following features:

The body has in x-, y- and z orthogonal axes and is made of a mixture of first and second materials (see the x-, y- and z orthogonal axes in FIG. 7).

In a first cross-section in an x-y plane parallel to the x- and y axes (see 140A in FIG. 8A), a ratio of the first and second materials changes on a first line (see XA1 in FIG. 8A) in a direction parallel to the x axis and changes in a direction parallel to the y axis (see XB1 in FIG. 8A).

In the first cross-section in an x-y plane (see 140A in FIG. 8A), the ratio of the first and second materials changes on a second line (see XB1 in FIG. 8A) spaced from the first line (see XA1 and XB1 in FIG. 8A) in a direction parallel to the x axis.

In a second cross-section in an x-y plane parallel to the x- and y axes (see 140B in FIG. 8B), spaced from the first cross-section in an x-y plane (see 140A and 140B in FIG. 7), a ratio of the first and second materials changes on a first line (see XA2 in FIG. 8B) in a direction parallel to the x axis and changes in a direction parallel to the y axis (see XB2 in FIG. 8B).

In the second cross-section in an x-y plane (see 140B in FIG. 8B), the ratio of the first and second materials changes on a second line (see XB2 in FIG. 8B) spaced from the first line (see XA2 and XB2 in FIG. 8B) in a direction parallel to the x axis.

In a cross-section in an x-z plane parallel to the x-and z axes (see 140C in FIG. 8C), a ratio of the first and second materials changes on a first line (see XA3 in FIG. 8C) in a direction parallel to the x axis and changes in a direction parallel to the z axis (see XB3 in FIG. 8B).

In the cross-section in an x-z plane parallel to the x- and z axes (see 140C in FIG. 8C), a ratio of the first and second materials changes on a second line (see XB3 in FIG. 8B) spaced from the first line (see XA3 and XB3 in FIG. 8C) in a direction parallel to the x axis.

In the cross-section in an x-z plane parallel to the x- and z axes (see 140C in FIG. 8C), a ratio of the first and second materials changes on a first line (see ZA1 in FIG. 8C) in a direction parallel to the z axis.

In the cross-section in an x-z plane parallel to the x-and z axes (see 140C in FIG. 8C), a ratio of the first and second materials changes on a second line (see ZB1 in FIG. 8C) spaced from the first line (see ZA1 and ZB1 in FIG. 8C) in a direction parallel to the z axis.

Fast Fourier Transfer (FFT) acceleration/deceleration algorithms have been developed in order to print an accurate functional gradient. The FFT calculates necessary changes in print speed as a function of both velocity and material composition.

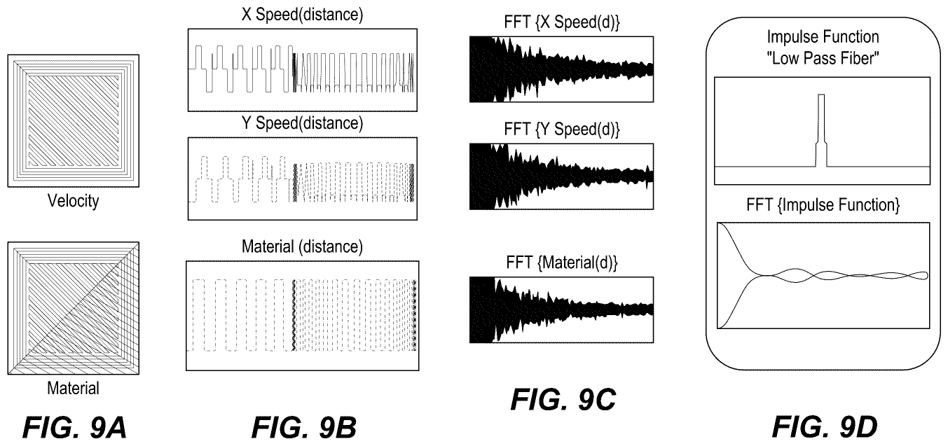

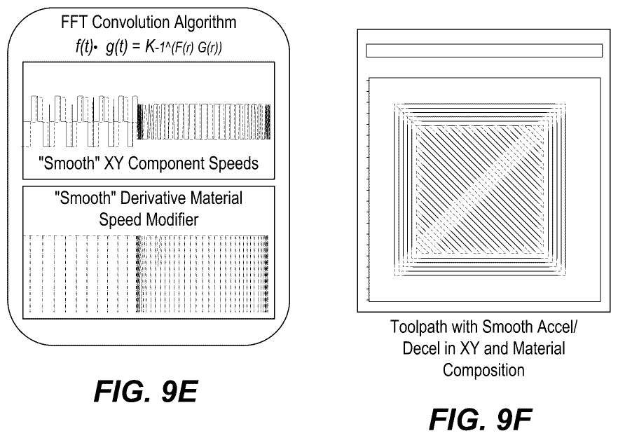

FIG. 9A shows the toolpath segment print path and the point cloud slice describing the material composition in the toolpath. In FIG. 9B, the component speeds are calculated as a function of path distance for x- and y-directions based on the programmed print speed for the segment. The material composition as a function of path distance is also calculated using the functional gradient point cloud data. In FIG. 9C, the Fourier Transform of the x-speed, y-speed, and material arrays are calculated using an FFT routine. In FIG. 9D, an Impulse Function is defined based on the physical properties of the printer. The printer, in general, uses a dual-value Impulse Function of 10 mm and 5 mm. This roughly equates to a “lookahead” distance of 10 mm and 5 mm in the acceleration/deceleration calculation, which has the effect of “smoothing” the changes in speed during the printing process. After calculating the form of the Impulse Function, the Fourier Transform of the function is calculated using the same FFT algorithm. In FIG. 9E, the “smoothed” speeds on the x- and y-axes and the “smoothed” material changes with distance are calculated using the convolution theorem, which states that the Fourier Transform of a convolution of two functions is a product of their Fourier Transforms. The FFT convolution algorithm calculates the convolution of two functions (e.g., x speed * impulse, y speed*impulse, material*impulse) by calculating the inverse Fourier Transform of the product of the previously calculated FFT arrays. The “smoothed” x-speed and y-speed arrays are then multiplied by the “smoothed” material array. The latter of which further modifies the x-and y-speeds to account for rapid changes in the material composition with distance. The result is shown in FIG. 9F where it is seen that the printhead not only decelerates and accelerates with changes in velocity in the toolpath, but with rapid changes in the material composition along the diagonal of the print segment.

The material ratio acceleration determinator 92 executes a method that includes:
a) calculating speed in an X direction and a Y direction in a print segment;
b) calculating a powder mixture composition in the X direction and the Y direction in the print segment;
c) calculating a Fourier transform of the speed in the X direction and a Fourier transform of the speed in the Y direction;
d) calculating a Fourier transform of the powder mixture composition in the X direction and a Fourier transform of the powder mixture composition in the Y direction;
e) calculating a Fourier transform of an impulse function specific to the printer hardware that acts as a low pass filter;
f) calculating acceleration/deceleration speed along the X direction by taking an inverse Fourier transform of the product of the Fourier transforms of the speed in the X direction and the Fourier transform of the impulse function;
g) calculating acceleration/deceleration speed along the Y direction by taking an inverse Fourier transform of the product of the Fourier transforms of the speed in the Y direction and the Fourier transform of the impulse function;
h) calculating an acceleration/deceleration multiplier for the material along the X direction by taking an inverse Fourier transform of the product of the Fourier transforms of the powder mixture composition in the X direction and the Fourier transform of the impulse function;
i) calculating an acceleration/deceleration multiplier for the material along the Y direction by taking an inverse Fourier transform of the product of the Fourier transforms of the powder mixture composition in the Y direction and the Fourier transform of the impulse function;
j) calculating acceleration/deceleration in the X direction as a function of speed and material composition by taking the product of the acceleration/deceleration speed along the X direction and the acceleration/deceleration multiplier for the material along the X direction; and
k) calculating acceleration/deceleration in the Y direction as a function of speed and material composition by taking the product of the acceleration/deceleration speed along the Y direction and the acceleration/deceleration multiplier for the material along the Y direction.

The material ratio acceleration determinator 92 thereby determines acceleration/deceleration of a printhead as a function of both changes in the velocity in an XY plane and changes in the powder mixture in the XY plane.

Part fabrication can be carried out using non-conformal welded hot isostatic press (HIP) cans. Multi-material 3D functional gradient printing technology allows for the 3D printing of a functionally-graded part and supporting powders in a non-conformal welded HIP can. After printing is complete, the can is degassed and sealed for HIP processing. During the HIP process, the metal powder mixture sinters and consolidates under pressure transferred through the supporting powder. The supporting powder may remain loose during the HIP process or can be selected to sinter along with the metal powder with the requirement that it is easily separated from the part after HIP processing. This approach eliminates the need to fabricate a conformal HIP can (i.e. a HIP can in the shape of the part) and is only limited to the size of the multi-material functional gradient 3D printer and the dimensions of the HIP.

These manufacturing processes not only allow for the fabrication of complex parts with functional gradients and the in-process monitoring of the gradient powder mixture, but have the potential to reduce the unit cost of conventional powder metallurgy (PM) HIP parts through the elimination of the conformal welded HIP can fabrication in the PM-HIP manufacturing process.

The invention provides a method of forming a part that includes printing successive layers, wherein each layer comprises at least a layer of the part and wherein the layer of the part is surrounded by a piece of a hot-isostatic press HIP can.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A printing system comprising:
a frame;
first and second hoppers to hold first and second powders respectively;
a movable mechanism mounted to the frame;
a printhead mounted through the movable mounting mechanism to the frame and connected to the first and second powder hoppers;
a print surface mounted to the frame;
at least one motor connected between the frame and the movable mounting mechanism to move the printhead relative to the print surface;
at least one processor;
a computer-readable medium connected to the at least one processor;
a toolpath stored on the computer-readable medium;
a varying ratio stored on the computer-readable medium;
a set of instructions on the computer-readable medium and executable by the at least one processor, including:
a printhead controller logically connected to the toolpath and the varying ratio, the at least one motor being connected to the at least one processor for the printhead controller to move the printhead relative to the print surface and print a mixture of the first and second powders in accordance with the varying ratio along the toolpath.

2. The printing system of claim 1, wherein the set of instructions includes:
a toolpath generator to generate the toolpath and store the toolpath on the computer-readable medium; and
a material ratio generator to determine the varying ratio of first and second powders along the toolpath and store the varying ratio along the toolpath on the computer-readable medium.

3. The printing system of claim 1, wherein the toolpath includes sections in each of a plurality of layers.

4. The printing system of claim 3, wherein each section has a two-dimensional shape.

5. The printing system of claim 1, further comprising:
a toolpath velocity along the toolpath stored on the computer-readable medium, wherein the printhead controller is operable to move the printhead relative to the print surface and print the first and second powders in accordance with the toolpath velocity along the toolpath.

6. The printing system of claim 5, further comprising:
a toolpath acceleration determinator stored on the computer-readable medium and executable by the at least one processor to generate the toolpath velocity along the toolpath and store the toolpath velocity along the toolpath on the computer-readable medium.

7. The printing system of claim 1, further comprising:
a material dispensing rate along the toolpath stored on the computer-readable medium, wherein the printhead controller is operable to move the printhead relative to the print surface, and print the first and second powders in accordance with the material dispensing rate along the toolpath.

8. The printing system of claim 7, further comprising:
a material ratio acceleration determinator stored on the computer-readable medium and executable by the at least one processor to generate the material dispensing rate along the toolpath, and store the material dispensing rate along the toolpath on the computer-readable medium.

9. The printing system of claim 1, wherein the printhead includes:
first and second separate powder fluidization chambers for receiving the first and second powders from the first and second hoppers respectively; and
at least a first separate powder vibration actuator connected to the first separate powder fluidization chamber to fluidize the first powder.

10. The printing system of claim 9, wherein the printhead includes:
at least a second separate powder vibration actuator connected to the second separate powder fluidization chamber to fluidize the second powder.

11. The printing system of claim 9, wherein the printhead includes:
first and second separate powder metering shutters for receiving the first and second powders from the first and second separate powder fluidization chambers and operable by the printhead controller to control dispensing of the first and second powders respectively.

12. The printing system of claim 11, wherein the printhead controller controls at least one of frequency, duty cycle and opening area of the first and second separate powder metering shutters.

13. The printing system of claim 1, wherein the printhead includes:
a mixed powder fluidization chamber for receiving the first and second powders from the first and second hoppers respectively; and
a mixed powder vibration actuator connected to the mixed separate powder fluidization chamber to fluidize the first and second powders in the mixed powder fluidization chamber.

14. The printing system of claim 1, wherein the printhead includes:
a mixed powder shutter for receiving the first and second powders from the first and second hoppers respectively and operable by the printhead controller to control dispensing of the mixture.

15. The printing system of claim 1, wherein the printhead includes:
a transducer to measure the mixture.

16. The printing system of claim 15, wherein the transducer is a radio frequency transducer.

17. Using a printer comprising:
a frame;
first and second hoppers to hold first and second powders respectively;
a movable mechanism mounted to the frame;
a printhead mounted through the movable mounting mechanism to the frame and connected to the first and second powder hoppers;
a print surface mounted to the frame;
at least one motor connected between the frame and the movable mounting mechanism to move the printhead relative to the print surface;
at least one processor; and
a computer-readable medium connected to the at least one processor,
a method of making a part comprising:
storing a toolpath on the computer-readable medium;
storing a varying ratio on the computer-readable medium;
storing a set of instructions on the computer-readable medium; and
executing the set of instructions by the at least one processor, including:
executing a printhead controller logically connected to the toolpath and the varying ratio, the at least one motor being connected to the at least one processor for the printhead controller to move the printhead relative to the print surface and print a mixture of the first and second powders in accordance with the varying ratio along the toolpath.

18. The method of claim 17, further comprising:
executing by the at least one processor a toolpath generator stored on the computer-readable medium to generate the toolpath and store the toolpath on the computer-readable medium; and
executing by the at least one processor a material ratio generator stored on the computer-readable medium to determine the varying ratio of the first and second powders along the toolpath and store the varying ratio along the toolpath on the computer-readable medium.

19. The method of claim 17, wherein the toolpath includes sections in each of a plurality of layers.

20. The method of claim 19, wherein each section has a two-dimensional shape.

21. The method of claim 17, further comprising:
storing a toolpath velocity along the toolpath on the computer-readable medium, wherein the printhead controller is operable to move the printhead relative to the print surface and print the first and second powders in accordance with the toolpath velocity along the toolpath.

22. The method of claim 21, further comprising:
executing by the at least one processor a toolpath acceleration determinator on the computer-readable medium to generate the toolpath velocity along the toolpath and store the toolpath velocity along the toolpath on the computer-readable medium.

23. The method of claim 17, further comprising:
storing a material dispensing rate along the toolpath on the computer-readable medium, wherein the printhead controller is operable to move the printhead relative to the print surface and print the first and second powders in accordance with the material dispensing rate along the toolpath.

24. The method of claim 23, further comprising:
executing by the at least one processor a material ratio acceleration determinator stored on the computer-readable medium to generate the material dispensing rate along the toolpath and store the material dispensing rate along the toolpath on the computer-readable medium.

25. The method of claim 17, wherein the printhead includes:
first and second separate powder fluidization chambers for receiving the first and second powders from the first and second hoppers respectively, further comprising:
operating at least a first separate powder vibration actuator connected to the first separate powder fluidization chamber to fluidize the first powder.

26. The method of claim 25, further comprising:
operating at least a second separate powder vibration actuator connected to the second separate powder fluidization chamber to fluidize the second powder.

27. The method of claim 25, further comprising:
operating by the printhead controller first and second separate powder metering shutters receiving the first and second powders from the first and second separate powder fluidization chambers to control dispensing of the first and second powders respectively.

28. The method of claim 27, wherein the printhead controller controls at least one of frequency, duty cycle and opening area of the first and second separate powder metering shutters.

29. The method of claim 17, wherein the printhead includes:
a mixed powder fluidization chamber for receiving the first and second powders from the first and second hoppers respectively, further comprising:
operating a mixed powder vibration actuator connected to the mixed separate powder fluidization chamber to fluidize the first and second powders in the mixed powder fluidization chamber.

30. The method of claim 17, further comprising:
operating by the printhead controller a mixed powder shutter receiving the first and second powders from the first and second hoppers respectively to control dispensing of the mixture.

31. The method of claim 17, further comprising:
measuring the mixture with a transducer.

32. The method of claim 31, wherein the transducer is a radio frequency transducer.

33. The method of claim 17, wherein the part includes:
a body having in x-, y- and z orthogonal axes and being made of a mixture of first and second materials, wherein, in a first cross-section in an x-y plane parallel to the x- and y axes, a ratio of the first and second materials changes on a first line in a direction parallel to the x axis and changes in a direction parallel to the y axis.

34. The method of claim 17, wherein,
in the first cross-section in an x-y plane, the ratio of the first and second materials changes on a second line spaced from the first line in a direction parallel to the x axis.

35. The method of claim 17, wherein,
in a second cross-section in an x-y plane parallel to the x- and y axes, spaced from the first cross-section in an x-y plane, a ratio of the first and second materials changes on a first line in a direction parallel to the x axis and changes in a direction parallel to the y axis.

36. The method of claim 35, wherein, in the second cross-section in an x-y plane, the ratio of the first and second materials changes on a second line spaced from the first line in a direction parallel to the x axis.

37. The method of claim 17, wherein, in a cross-section in an x-z plane parallel to the x- and z axes, a ratio of the first and second materials changes on a first line in a direction parallel to the x axis and changes in a direction parallel to the z axis.

38. The method of claim 35, wherein, in the cross-section in an x-z plane parallel to the x- and z axes, a ratio of the first and second materials changes on a second line spaced from the first line in a direction parallel to the x axis.

39. The method of claim 37, wherein, in the cross-section in an x-z plane parallel to the x- and z axes, a ratio of the first and second materials changes on a first line in a direction parallel to the z axis.

40. The method of claim 39, wherein, in the cross-section in an x-z plane parallel to the x- and z axes, a ratio of the first and second materials changes on a second line spaced from the first line in a direction parallel to the z axis.

41. The method of claim 17, wherein the first and second materials are in the form of first and second powders in the mixture.

42. The method of claim 41, wherein the first and second powders are loose.

43. The method of claim 17, wherein the materials are consolidated so that the body is a stand-alone body.

44-68. (canceled)
